(19) United States
(12) Patent Application Publication
(10) Pub. No.: US 2012/0038941 A1
(43) Pub. Date: Feb. 16, 2012

(54) IMAGE FORMING APPARATUS, INFORMATION PROCESSING APPARATUS, IMAGE FORMING SYSTEM, AND IMAGE FORMING METHOD

(75) Inventor: Shunichi MEGAWA, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/196,692

(22) Filed: Aug. 2, 2011

Related U.S. Application Data
(60) Provisional application No. 61/372,441, filed on Aug. 10, 2010.

(51) Int. Cl. G06K 15/00; G06F 3/12

(52) U.S. Cl. 358/1.13; 358/1.14

(57) ABSTRACT

According to one embodiment, an image forming apparatus includes: an input section configured to input information to be printed; a first printing section configured to perform printing with a toner unerasable by an erasing device; a second printing section configured to perform printing with a toner erasable by the erasing device; and a control section configured to control the image forming apparatus to print, using the first printing section, at least a keyword stored in a storing section in advance among the information to be printed input by the input section and control the image forming apparatus to print, using the second printing section, information not printed by the first printing section.

### CROSS-REFERENCE TO RELATED APPLICATION

This application is based upon and claims the benefit of priority from: U.S. provisional application 61/372,441, filed on Aug. 10, 2010; the entire contents all of which are incorporated herein by reference.

### FILED

Embodiments described herein relate generally to a technique for preventing leakage of information.

### BACKGROUND

In the past, an image forming apparatus including a unit configured to perform printing with an unerasable toner and a unit configured to perform printing with an erasable toner is developed.

Even after the erasable toner is erased, in some cases, the erased toner develops a color again according to a temperature change or the like. If a confidential document is erased after being printed with an erasable toner and flows out to outside the company, the confidential document develops a color again, changes to a visible state, and flows out to outside the company.

### DESCRIPTION OF THE DRAWINGS

FIG. 1 is a schematic diagram of the configuration of an image forming system according to a first embodiment;

FIG. 2 is a block diagram of an image forming apparatus according to the first embodiment;

FIG. 3 is a flowchart for explaining an operation example of the image forming apparatus according to the first embodiment;

FIG. 4A is a diagram of an example of a watermark;

FIG. 4B is a diagram for explaining woven pattern printing;

FIG. 5 is a flowchart for explaining an operation example of the image forming apparatus according to the first embodiment in the case of acquisition of a page description language;

FIG. 6A is a diagram of an example of the page description language;

FIG. 6B is a diagram of an example of a raster image;

FIG. 7 is a diagram for explaining a problem in the past;

FIGS. 8A and 8B are diagrams of operation examples to which the image forming apparatus according to the first embodiment is applied;

FIG. 9 is a flowchart for explaining an operation example of an image forming apparatus according to a second embodiment;

FIG. 10 is a diagram of examples of an original document, a first image, and a second image in a second embodiment;

FIG. 11 is a flowchart for explaining an operation example of an image forming apparatus according to the second embodiment in the case of acquisition of a page description language;

FIG. 12 is a diagram for explaining an operation example of the image forming apparatus according to the second embodiment;

FIG. 13 is a diagram of an example of a PDL written when a PC according to the second embodiment determines keywords; and

FIG. 14 is a diagram for explaining an operation example of the PC according to the second embodiment in the case of using of a sheet having a watermark.

### DETAILED DESCRIPTION

In general, according to one embodiment, an image forming apparatus includes: an input section configured to input information to be printed; a first printing section configured to perform printing with a toner unerasable by an erasing device; a second printing section configured to perform printing with a toner erasable by the erasing device; and a control section configured to control the image forming apparatus to print, using the first printing section, at least a keyword stored in a storing section in advance among the information to be printed input by the input section and control the image forming apparatus to print, using the second printing section, information not printed by the first printing section.

In embodiments explained below, an image forming system is explained that determines whether a keyword such as “company secret” is present in an original document. In a first embodiment, an image forming system is explained that prints, if a keyword is detected, an entire page including the keyword with an unerasable toner and prints, if a keyword is not detected, the entire page with an erasable toner. In a second embodiment, an image forming system is explained that prints a keyword such as “company secret” and an area including the keyword with an unerasable toner and prints other areas of a page with an erasable toner.

### First Embodiment

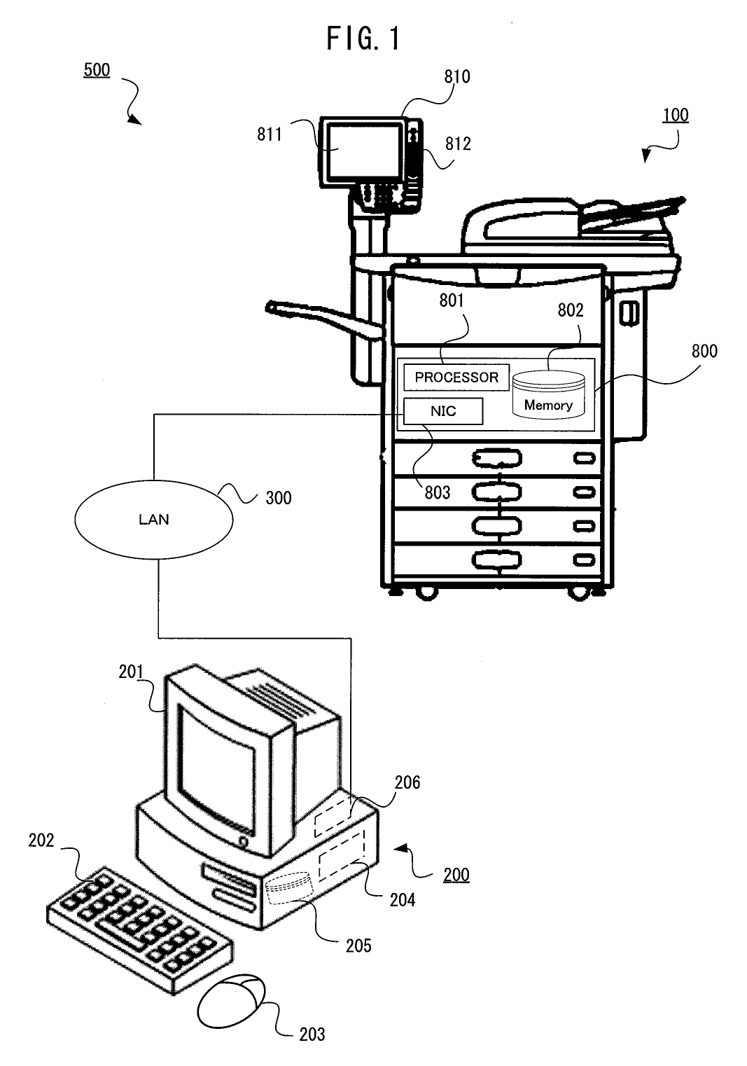

FIG. 1 is a diagram of an example of a system configuration of a first embodiment. An image forming system 500 includes an image forming apparatus 100, which is an MFP (Multifunction Peripheral), having a copying function, a printer function, a scanner function, and a transmitting and receiving function for facsimile and email and a PC (Personal Computer) 200, which is an information processing apparatus, used by a user. The image forming apparatus 100 and the PC 200 are connected by a LAN (Local Area Network) 300 and can communicate with each other.

The image forming apparatus 100 includes a control board 800 configured to collectively control hardware devices in the apparatus. The control board 800 includes a processor 801, which is an arithmetic processing unit, such as a CPU (Central Processing Unit) or an MPU (Micro Processing Unit). The control board 800 includes a memory 802 including a RAM (Random Access Memory), which is a volatile storage device, and a ROM (Read Only Memory) and a HDD (Hard Disk Drive), which are nonvolatile storage devices. Further, the control board 800 includes a NIC (Network Interface Card) 803 configured to control communication with the outside.

The image forming apparatus 100 includes a control panel 810 including a keyboard 812 configured to receive an instruction from a user and a touch panel display 811 configured to display control contents and receive an instruction from the user.

A hardware configuration of the PC 200 is the same as that of an existing PC. The PC 200 includes a processor 204, a memory 205, and a NIC 206. Further, the PC 200 includes a keyboard 202 and a mouse 203 configured receive an input from the user and a monitor 201 configured to display an image to the user. The NIC 803 and the NIC 206 perform control of communication with each other via the LAN 300.

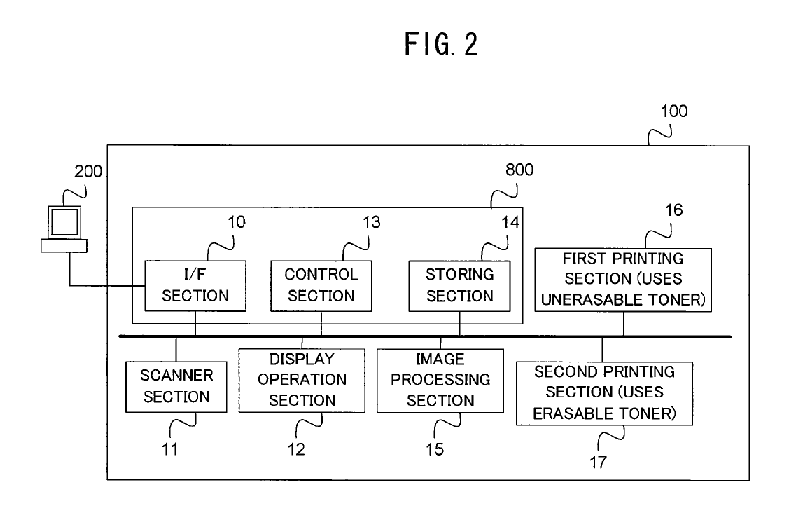

A schematic configuration of the image forming apparatus 100 is shown in FIG. 2. The image forming apparatus 100 can perform printing with two kinds of toners, i.e., a toner erasable by an erasing device and a toner unerasable by the erasing device.

The image forming apparatus 100 includes two input sections, i.e., an I/F section 10 (I/F: Interface) connected to the PC 200 through the LAN 300 and connected to a USB (Universal Serial Bus) memory and a scanner section 11 configured to read a document image. The image forming apparatus 100 includes a display operation section 12 for the user to perform various kinds of operation and a control section 13 configured to manage the control of the entire image forming apparatus 100. The image forming apparatus 100 includes a storing section 14 configured to store a control program, data, and the like. The image forming apparatus 100 includes an image processing section 15 configured to apply various kinds of image processing such as gradation correction and edge detection processing to data to be printed acquired by the I/F section 10 and the scanner section 11. The image processing section 15 is mounted as an ASIC (Application Specific Integrated Circuit).

The image forming apparatus 100 includes a first printing section 16 configured to form an image on a sheet with a toner unerasable by an erasing device used by the user (an erasing device 400) and a second printing section 17 configured to form an image on a sheet with a toner erasable by the erasing device 400. Each of the first printing section 16 and the second printing section 17 includes photoconductive drums configured to perform printing with toners of four colors, cyan, magenta, yellow, and black. The photoconductive drums are individually arranged in a sheet conveying direction.

The control section 13 corresponds to the processor 801 and the storing section 14 corresponds to the memory 802. The display operation section 12 corresponds to the control panel 810. The I/F section 10 includes the NIC 803. The control section 13, the memory 802, and the I/F section 10 are mounted on the control board 800.

The operations of the image forming apparatus 100 are explained below. In the following explanation of the operations, first, an example in which a document image is read by the scanner section 11 and image data of the document image is processed is explained. Subsequently, an example in which data of a page description language is acquired from the PC 200 and the page description language is processed is explained.

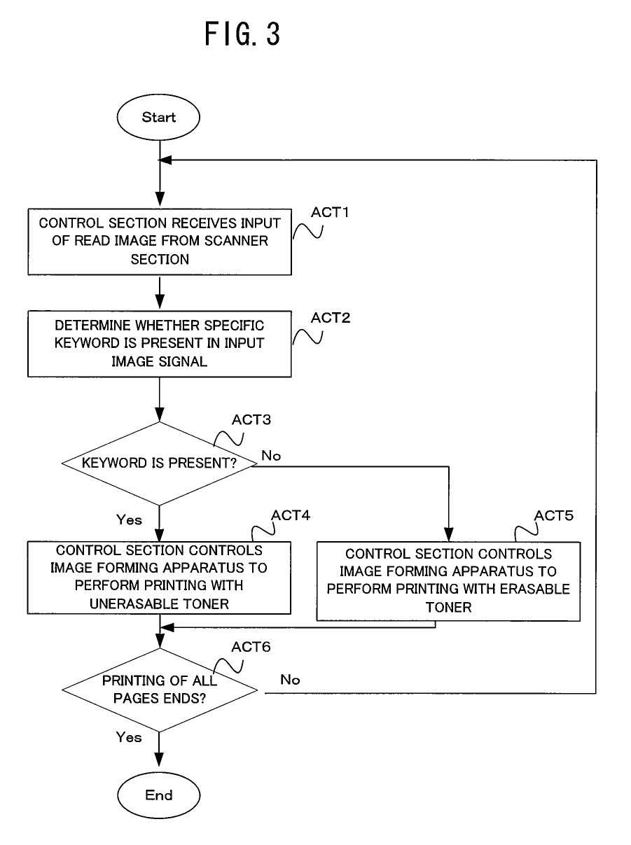

First, an operation example of the image forming apparatus 100 in the case of reading of an original document with the scanner section 11 is shown in a flowchart of FIG. 3. Respective kinds of processing by the control section 13 in the flowchart explained below are realized by the control section 13 executing an arithmetic operation of a computer program introduced in the storing section 14 in advance and the control section 13 causing the storing section 14 to store data.

The control section 13 receives the input of a read input image from the scanner section 11 (ACT 1). The control section 13 determines whether a keyword registered in advance is present in the input image (ACT 2).

A determination method in ACT 2 is explained. First, the control section 13 executes a layout analysis and extracts a character string. As a layout analysis technique, a publicly-known technique can be used. The control section 13 extracts a character string present in a header or a footer in a document image. The control section 13 limits, for example, character strings extracted from the original document to a character string having a Y coordinate equal to or smaller than a certain threshold or equal to or larger than the threshold to regard the character string as the header or the footer.

Subsequently, the control section 13 executes processing by an OCR (Optical Character Reader) on the extracted character string and recognizes the character string. Finally, the control section 13 determines whether the recognized character string coincides with a registered character string stored in the storing section 14 in advance. If the character strings coincide with each other, the control section 13 determines that a keyword is present.

If an image pattern (e.g., a logo or a seal of a company) is registered in the storing section 14 as a keyword, the control section 13 determines whether an image pattern registered in advance is present on an input image using a pattern matching technique (a publicly-known technique can be used as the pattern matching technique). Further, an implementation may be adopted in which the control section 13 determines presence or absence of a keyword from a character string obtained as a result of reading and decoding a barcode (a one-dimensional barcode or a two-dimensional barcode) on an original document.

Referring back to the flowchart of FIG. 3, if the control section 13 determines that a keyword is absent in the determination in ACT 2 (No in ACT 3), the control section 13 controls the second printing section 17 to print an image to be processed such that the image is erasable by the erasing device 400 (ACT 5). On the other hand, if the control section 13 determines that a keyword is present (Yes in ACT 3), the control section 13 controls the first printing section 16 to print an image to be processed such that the image is unerasable by the erasing device 400 (ACT 4).

Thereafter, a sheet is fed from a paper feeding cassette to a transfer section and a toner is deposited on the sheet according to an input image signal.

If printing of all pages does not end (NO in ACT 6), the processing proceeds to ACT 1.

In this embodiment, each of the first printing section 16 and the second printing section 17 includes photoconductive units for the respective colors. However, for example, there is also a configuration in which the first printing section 16 and the second printing section 17 share one set of photoconductive drums (for cyan, magenta, yellow, and black). As the control method in ACTS 4 and 5 in this configuration, if the image is printed with an erasable toner, the toner is supplied to the photoconductive drums from a toner cartridge for the erasable toner. If the image is printed with an unerasable toner, the toner is supplied to the photoconductive drums from a toner cartridge in which the unerasable toner is stored.

In the above explanation, the control section 13 determines presence or absence of a keyword. However, not only the control section 13 but also the image processing section 15 can perform the keyword determination.

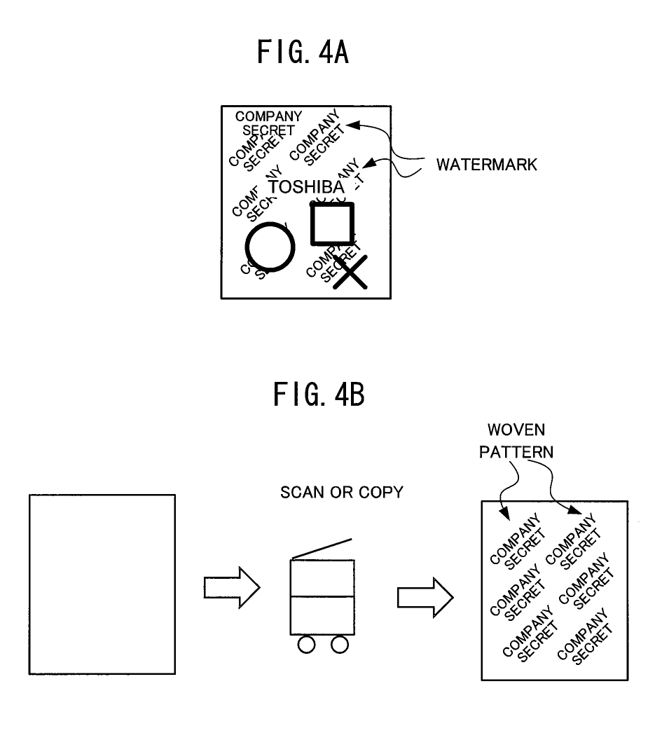

A detection target is not limited to a keyword and may be a mark such as a seal, a one-dimensional barcode, and a two-dimensional code represented by a QR code. The detection target may be a watermark such as a background pattern shown in FIG. 4A and a woven pattern print that appears on a copied or scanned print.

In the above explanation, the control section 13 determines presence or absence of a keyword for each page and performs, for each page, control concerning with which of the unerasable toner and the erasable toner an image is printed. However, for example, it is conceivable that, if a keyword is present in an arbitrary page, all the following pages are printed with the unerasable toner. Alternatively, an implementation is also conceivable in which input images of all pages are stored in the storing section 14 and, if it is determined that a keyword is present in at least one page, all the pages are printed with the unerasable toner and, if a keyword is absent, all the pages are printed with the erasable toner.

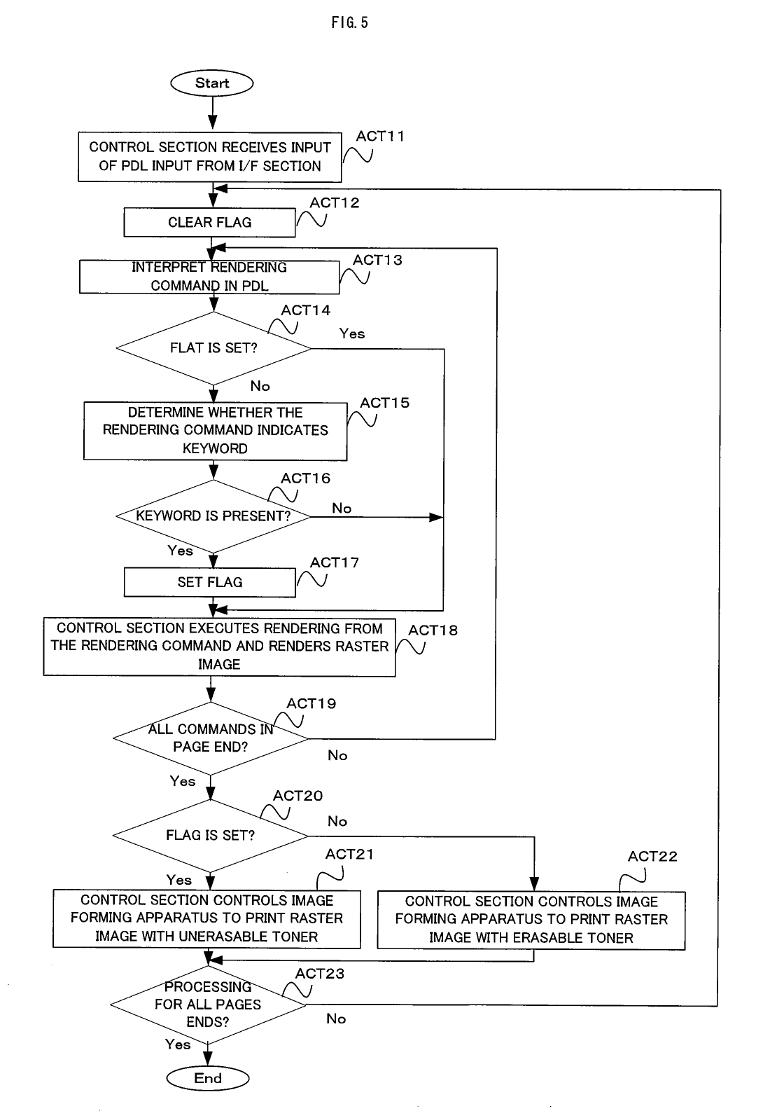

An example in which the PC 200 converts image data to be printed into a page description language (hereinafter referred to as PDL) and prints the image data on the basis of the PDL is explained with reference to a flowchart of FIG. 5.

The control section 13 receives, through the I/F section 10, the input of a PDL generated by a printer driver of the PC 200 (ACT 11). Subsequently, the control section 13 clears flag data (hereinafter simply referred to as flag) stored in the storing section 14 to 0 (ACT 12). The flag is information indicating whether a specific keyword is present in a page (one page) to be processed.

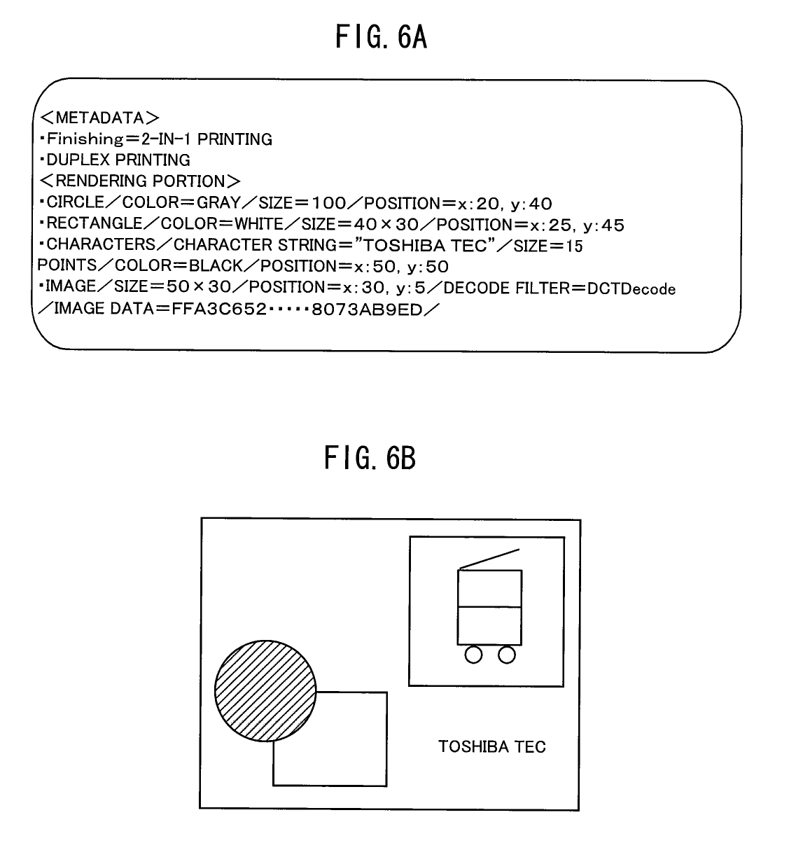

The control section 13 executes RIP processing and interprets a rendering command in the PDL (ACT 13). An example of the PDL is shown in FIG. 6A. The PDL in this embodiment is divided into two parts, i.e., meta data in which information concerning an entire printing target such as “2-in-1 printing” or “duplex printing” is defined and a rendering portion in which information concerning respective rendering commands is defined. The rendering command is prepared for each object and includes definition information in printing of objects such as an arrangement, a size, and a color. As the rendering commands, three commands are set: a character command concerning characters, a figure command concerning a figure, and an image command concerning an image. In ACT 13, the processing is performed in the order explained below.

The control section 13 acquires, for each command, a rendering command in the PDL.

The control section 13 acquires properties delimited by delimiters (in this example, “/” characters) in the acquired rendering command. If the object is the figure command such as “circle” or “rectangle” or the image command (a command head character string is “image”), properties such as a color and a size are acquired. If the object is the character command, properties such as a code, a font size, a color, and a font type of the character string are acquired.

The control section 13 determines whether a flag is set (whether the flag is a value other than 0) (ACT 14). If the flag is set (Yes in ACT 14), the processing jumps to ACT 18.

If the flag is not set (No in ACT 14), the control section 13 determines whether a specific keyword is present in the rendering command (ACT 15).

The processing in ACT 15 is explained. If the rendering command is the character command, the control section 13 acquires a character string code in the properties after interpreting the character command and determines whether the character string is a registered keyword. If the rendering command is the figure command or the image command, the control section 13 once creates the figure or the image on the basis of the properties and carries out pattern matching with an image pattern in the same manner as explained above.

If a keyword is absent (No in ACT 16), the processing proceeds to ACT 18. If a keyword is present (Yes in ACT 16), the control section 13 sets a flag (sets the flag to a value other than 0).

The control section 13 executes rendering processing according to the rendering command and renders a raster image (ACT 18). An example of the raster image created in ACT 18 is shown in FIG. 6B.

The control section 13 renders raster images respectively according to the rendering commands and determines whether interpretation of all the rendering commands in the page ends (Act 19). If the processing is not completed for all the rendering commands in the page (No in ACT 19), the processing returns to ACT 13. If the processing is completed (Yes in ACT 19), the control section 13 determines whether a flag is set (ACT 20).

If the flag is set (Yes in ACT 20), since the page includes a designated keyword, the control section 13 controls the image forming apparatus 100 to print the entire page with the unerasable toner, i.e., controls the image forming apparatus 100 to print the page using the first printing section. Conversely, if a flag is not set (No in ACT 20), since a designated keyword is not included, the control section 13 controls the image forming apparatus 100 to print the entire page with the erasable toner, i.e., controls the image forming apparatus to print the page using the second printing section (ACT 22). This control method is the same as ACTS 4 and 5 explained above.

If the processing for all the pages does not end (No in ACT 23), the processing returns to ACT 12 and processing for the next page is continued.

In this example, the flag is cleared during the start of processing for each page. However, if the flag is not cleared (i.e., in the case of NO in ACT 23, the processing is returned to ACT 13), it is also possible to print, if a keyword appears in an arbitrary page, all the following pages with the unerasable toner. If the raster image is once stored in a storage device and is printed after the determination of presence or absence of a keyword in all the pages ends, it is also possible to print all the pages with the unerasable toner or the erasable toner. In other words, if a keyword is present, all the pages are printed by the first printing section 16. If a keyword is absent, all the pages are printed by the second printing section 17.

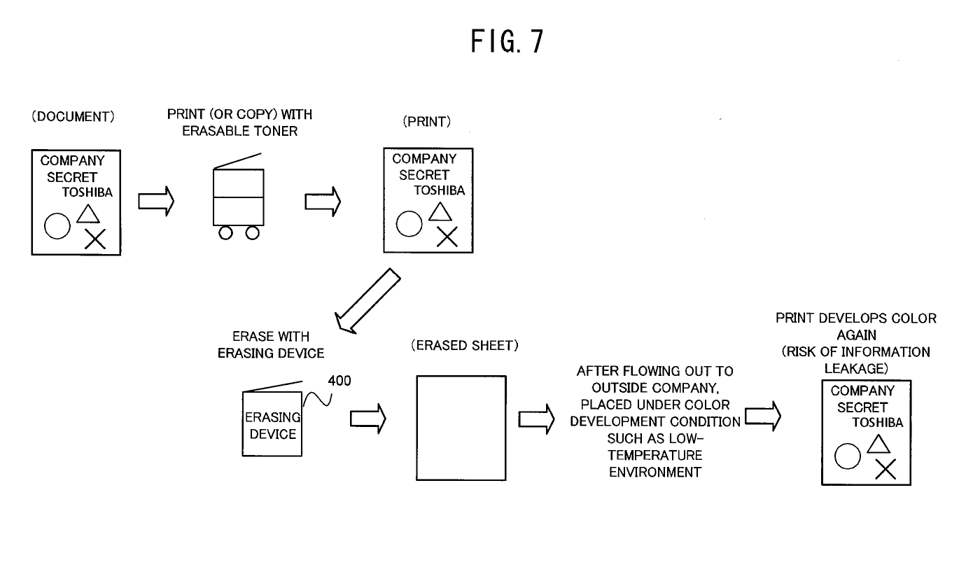

A form in the past and a form in the first embodiment are compared. FIG. 7 is a diagram for explaining a problem in the past. In a situation shown in the figure, an original document including confidential information is printed (or copied) with the toner erasable by the erasing device 400 and a printed sheet is erased by the erasing device 400 to reuse the sheet. Immediately after the erasing, no image is formed on the sheet. If the sheet is reused for other purposes, it is likely that the sheet passes into others' hands. If the sheet passes into others' hand, thereafter, if the sheet is placed under an environment such as a low-temperature environment, it is likely that the erased toner develops a color again and the confidential information flows out to outside the company.

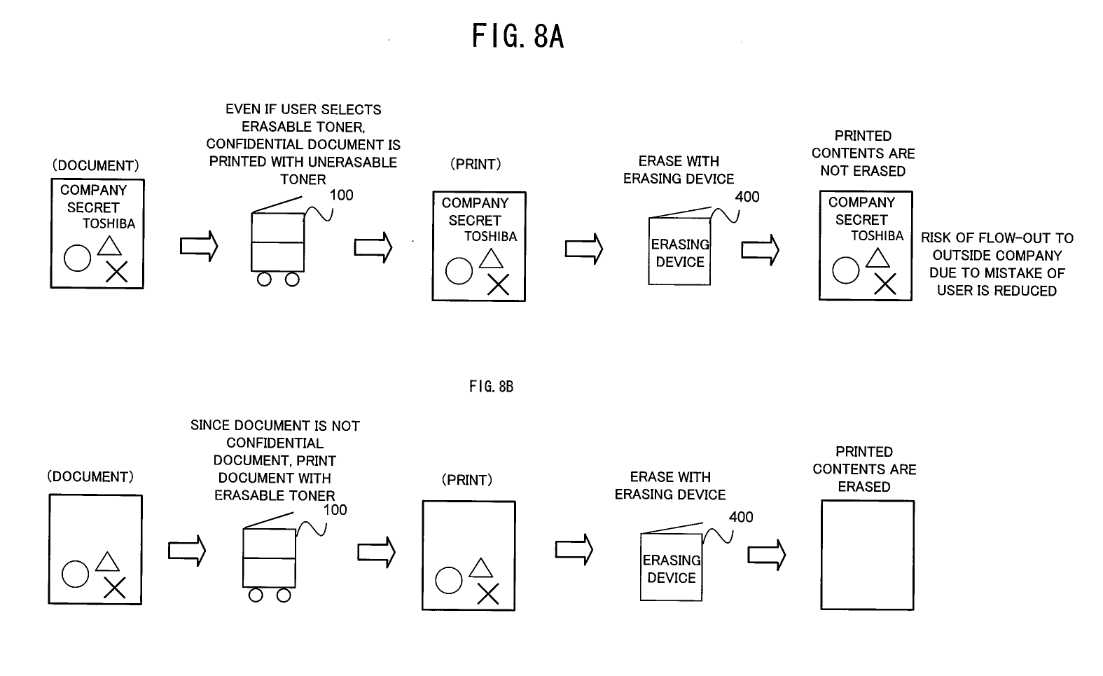

FIG. 8A is a diagram of a form in the case of printing of confidential information using the image forming apparatus 100. The image forming apparatus 100 prints the confidential information using the toner unerasable by the erasing device 400, even if the user attempts to erase a sheet using the erasing device 400, printed contents are not erased. Therefore, since the user can visually recognize that the confidential information is written on the sheet, it is possible to prevent the confidential information from flowing out to outside the company.

On the other hand, concerning a sheet not including confidential information as shown in FIG. 8B, since the toner erasable by the erasing device 400 is used, printed contents are erased by the erasing device 400 and the sheet can be reused.

With the configuration of this embodiment, when electronic data including confidential information is printed, the entire page is printed with the unerasable toner. In the example in which the PDL is used, since presence or absence of a keyword can be determined by an analysis of a command rather than character recognition processing (OCR processing), a risk of erroneous determination is small. Consequently, it is possible to reduce a risk of a sheet having confidential information recorded thereon flowing out to outside the company because of carelessness of the user to cause leakage of the confidential information.

### Second Embodiment

In a second embodiment, an implementation for printing only a keyword and an area including the keyword with an unerasable toner and printing areas other than the keyword and the area including the keyword using an erasable toner is explained. The configuration of an image forming system and the configurations of a PC and an image forming apparatus are the same as those in the first embodiment. Therefore, explanation of the configurations is omitted.

An operation example of the image forming apparatus 100 according to the second embodiment is explained. In the following explanation of operations, as in the first embodiment, first, an example in which a document image is read by the scanner section 11 and the image data is processed is explained. Subsequently, an example in which a PDL is acquired from the PC 200 and the PDL is processed is explained.

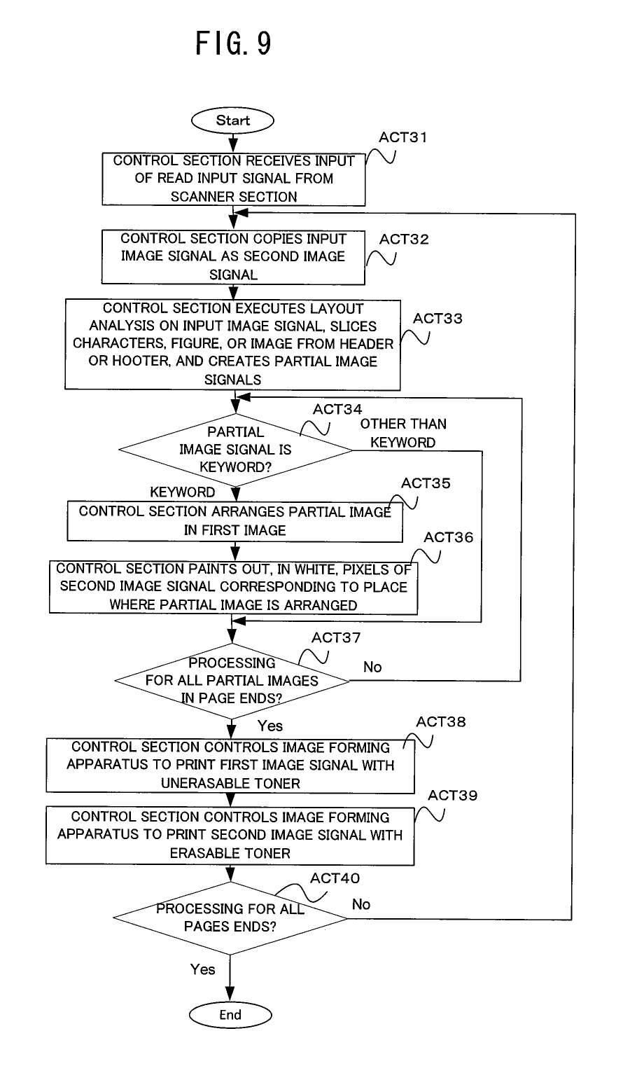

FIG. 9 is a flowchart for explaining an operation example of the image forming apparatus 100 according to the second embodiment in the case of reading of a document image with the scanner section 11.

The control section 13 receives the input of a read input image from the scanner section 11 (ACT 31), copies the input image, and creates a second image (ACT 32). The control section 13 executes a layout analysis on the input image, slices characters, a figure, or an image from a header section or a footer section of the input image, and creates partial images (ACT 33). As a layout analysis technique, a publicly-known technique can be used.

The control section 13 determines whether the partial images are keywords registered in advance (ACT 34). Details of a determination method in ACT 34 are as explained below.

If a partial image is a character image, the control section 13 executes OCR processing and recognizes a character string. If the recognized character string coincides with a character string stored in the storing section 14 in advance, the control section 13 determines that the partial image is a keyword. If an image pattern (e.g., a logo or a seal of a company) is registered as a keyword, the control section 13 determines whether an image pattern registered in advance is present on an input image using a pattern matching technique (a publicly-known technique can be used as the pattern matching technique).

Further, it is also conceivable to determine presence or absence of a keyword from a character string obtained as a result of reading and decoding a barcode (a one-dimensional barcode or a two-dimensional barcode) on an original document as in the first embodiment.

Processing in the next ACTS 35 and 36 is executed on the partial image determined as the keyword.

The control section 13 arranges the partial image in a first image in a position and a size (width and height) same as a position and a size of the partial image arranged in the input image (ACT 35). The first image is image data in which nothing is drawn in an initial state. The control section 13 paints out, in white, the position where the partial image is arranged in the second image (ACT 36).

If the processing in ACTS 32 to 36 does not end for all the partial images (No in ACT 37), the processing is repeatedly executed on all the partial images.

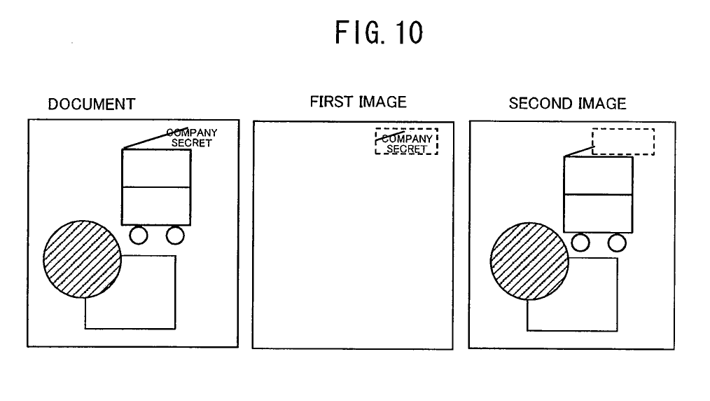

An example of the first image and the second image created in this way is shown in FIG. 10. An area including a keyword such as “company secret” on an original image is drawn on the first image. On the other hand, on the second image, the partial images other than the area of the keyword are rendered and the area including the keyword is painted out in white.

The control section 13 controls the first printing section 16 to print the first image (ACT 38) and controls the second printing section 17 to print the second image (ACT 39). In this way, the first image including the keyword is printed with the unerasable toner and the second image not including the keyword is printed with the erasable toner.

A specific control method performed when only one set of photoconductive drums (for cyan, magenta, yellow, and black) are provided is explained below. Operations explained below are performed on the basis of the control by the control section 13.

1. The unerasable toner is supplied to the photoconductive drums from a toner cartridge for the unerasable toner.

2. A sheet is fed from a paper feeding cassette to a transfer section. The unerasable toner is deposited on the sheet according to the first image.

3. The sheet on which the unerasable toner is deposited is not discharged at the present point. The erasable toner is supplied to the photoconductive drums.

4. The erasable toner is deposited on the sheet according to the second image.

5. The sheet on which the unerasable and erasable toners are deposited is discharged.

If printing of all pages does not end (No in ACT 40), the processing in ACTS 32 to 39 is executed until the printing of all the pages is completed.

By adopting such a configuration, as in the first embodiment, it is possible to reduce a risk of confidential information copied with the erasable toner flowing out to outside the company because of carelessness of a user to cause leakage of the confidential information. Since areas of a sheet other than a keyword indicating a confidentiality level (e.g., “company secret” or “department secret”) are erased, if a document having the same confidentiality level is printed, the sheet can be recycled and reused.

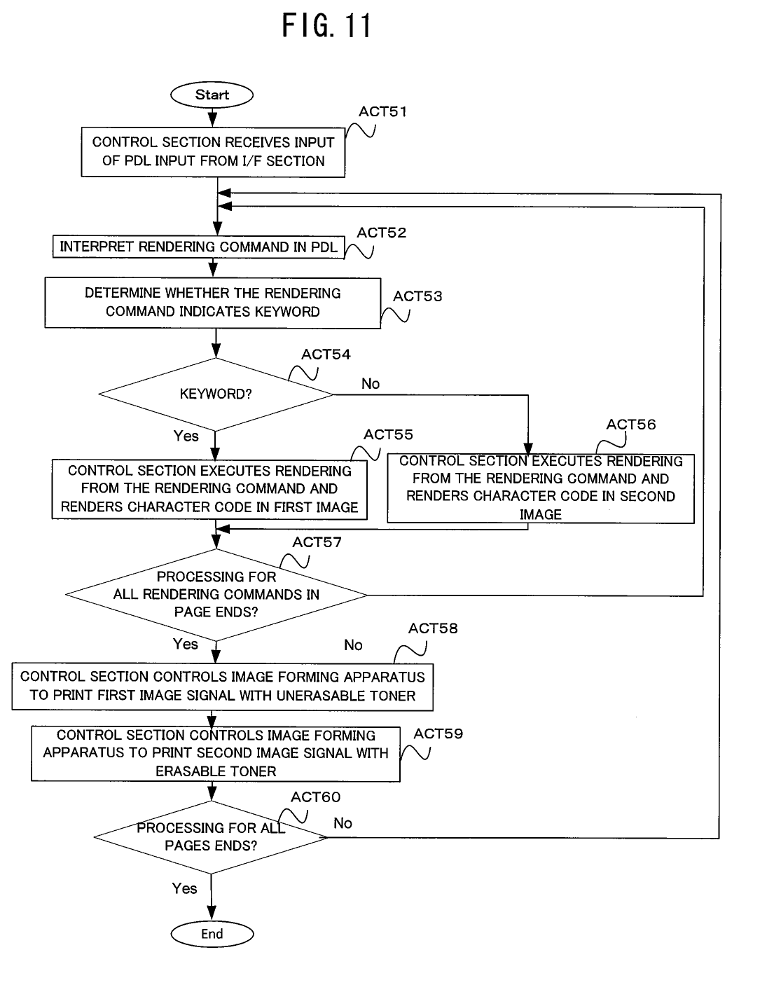

Subsequently, an operation example of the image forming apparatus 100 in the case of acquisition of a PDL from the PC 200 and applying of printing control to the acquired PDL is shown in a flowchart of FIG. 11.

The control section 13 receives, through the I/F 10, the input of a page description language (PDL) generated by the printer driver of the PC 200 (ACT 51).

The control section 13 executes RIP processing and interprets rendering commands in the PDL (ACT 52). The control section 13 renders each of the rendering commands in a first image (raster image) not to be erased or a second image (raster image) to be erased (ACTS 53 to 56).

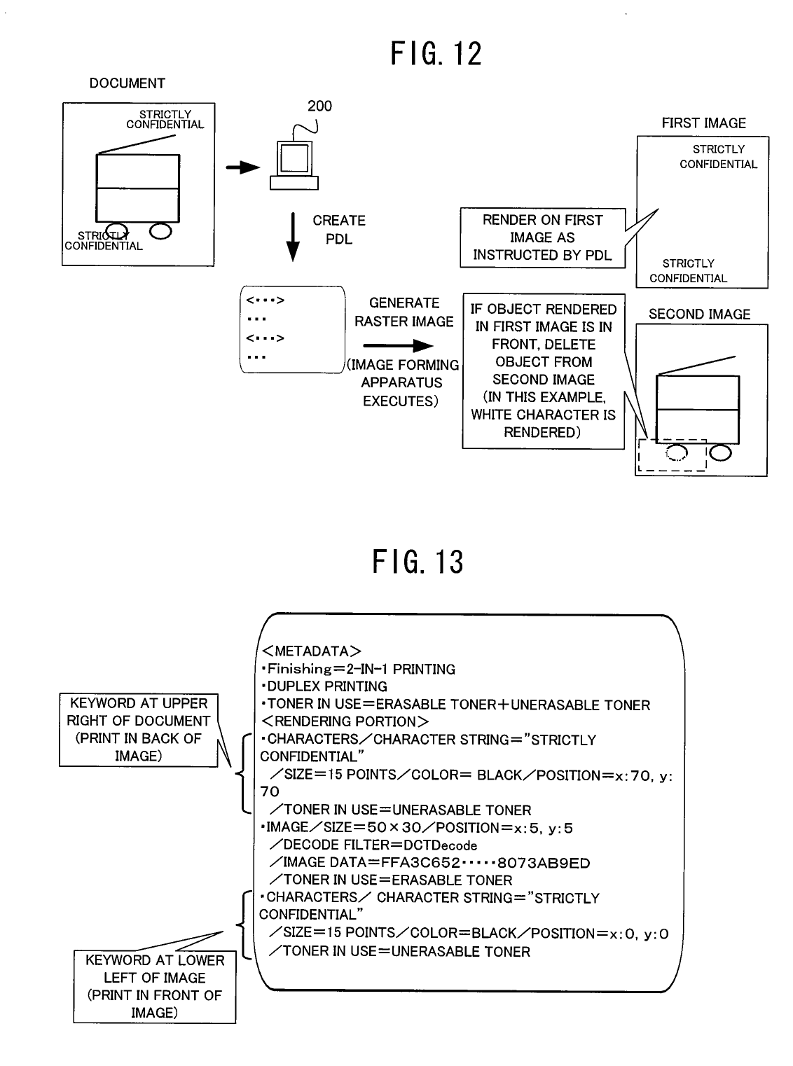

Processing in ACTS 53 to 56 is explained with reference to FIG. 12 as well. FIG. 12 is a diagram of examples of original image data, a PDL, a first image, and a second image generated in the processing.

If a rendering command is a character command, the control section 13 interprets the character command, checks a character code, and determines whether the character code is a registered keyword (ACT 53). If the character code is a registered keyword (Yes in ACT 54), the control section 13 renders the character code in the first image (ACT 55). If the character code is not a registered keyword (No in ACT 54), the control section 13 renders the character code in the second image (ACT 56).

Concerning a figure command or an image command, as in the first embodiment, the control section 13 carries out pattern matching with an image pattern to determine whether a figure or an image is a keyword (ACT 53). If the control section 13 determines that the target rendering command indicates a registered image pattern (Yes in ACT 54), the control section 13 renders an image as a result of interpreting the rendering command in the first image not to be erased (ACT 55). If the control section 13 determines that the target rendering command does not indicate a registered image pattern (No in ACT 54), the control section 13 renders the image in the second image to be erased (ACT 56).

However, in the related art, if images are drawn one on top of the other on the same pixel, only the image drawn after the image drawn earlier is erased is drawn. However, in the image forming apparatus, if objects are drawn one on top of the other in the same manner as the related art, it is likely that an important keyword such as “company secret” or “confidential” cannot be read if an image after printing is erased. Therefore, only if the first image not to be erased is drawn earlier in the same pixel position as the second image to be erased, pixels on the second image are replaced with white pixels. On the other hand, pixels on the first image are not replaced with white pixels. Consequently, the important keyword is surely printed with the unerasable toner while chances of the unerasable toner and the erasable toner being ejected in the same position on a sheet are reduced.

If the processing does not end for all the rendering commands in the same page (No in ACT 57), the processing is repeatedly executed on all the rendering commands.

The control section 13 controls the image forming apparatus 100 to print the first image with the unerasable toner (ACT 58) and print the second image with the erasable toner (ACT 59). In other words, the control section 13 controls the image forming apparatus to print the first image using the first printing section 16 and controls the image forming apparatus to print the second image using the second printing section 17. A control method is as explained above.

If a page currently being processed is not the last page (No in ACT 60), the processing returns to ACT 52.

In the example explained above, if the control section 13 of the image forming apparatus 100 performs interpretation and rendering of the rendering commands of the PDL as RIP, the control section 13 determines whether rendered characters and images should be printed with the unerasable toner or should be printed with the erasable toner. However, this determination can also be realized by the processor 204 of the PC 200 executing an arithmetic operation of a computer program of the printer driver. Specifically, if the processor 204 (the printer driver) of the PC 200 generates a PDL on the basis of electronic image data (GDI) output from an application, the processor interprets font data in the GDI, determines whether the font data is a keyword stored in the memory 205 in advance, and generates a PDL in which a symbol indicating which of the erasable toner and the unerasable toner is used is embedded.

A series of operations of the PC 200 are explained. The processor 204 of the PC 200 acquires an object in electronic data created by applications. The object is a font data of a character string in the case of character string information and is a raster image in the case of image data or figure data. The processor 204 acquires one or plural keywords stored beforehand from the memory 205 and determines whether the object is a keyword. In the case of the character string, the processor 204 determines whether a code coincides with a keyword or the object includes a code. In the case of the image or figure data, the processor 204 performs the determination using the pattern matching processing as described above. If the object is a keyword, the processor 204 gives, for example, a symbol of “unerasable toner” to the object and creates a rendering command. On the other hand, if the object is not a keyword, the processor 204 gives, for example, a symbol of “erasable toner” to the object and creates a rendering command. The processor 204 transmits the PDL created in this way to the image forming apparatus 100 as information to be printed.

An example of the PDL created by the PC 200 is shown in FIG. 13. The PDL shown in FIG. 13 is a PDL converted from the document data shown in FIG. 12 by the PC 200. The control section 13 of the image forming apparatus 100 acquires symbols included in the rendering commands to perform control concerning with which toner printing is performed. Specifically, the control section 13 renders a rendering object including the symbol of “unerasable toner” in the first image and controls the first printing section 16 to print the first image. The control section 13 renders a rendering object including the symbol of “erasable toner” in the second image and controls the second printing section 17 to print the second image.

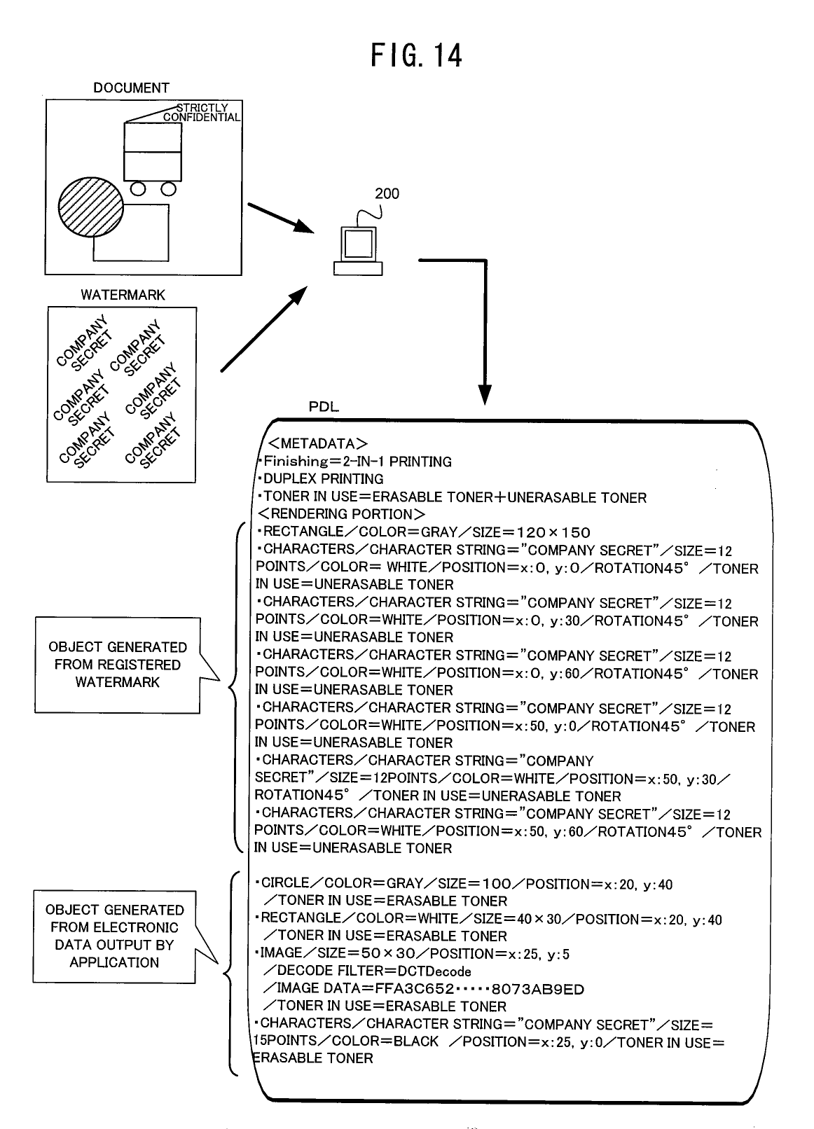

An implementation is also conceivable in which the processor 204 of the PC 200 determines whether a specific sheet having a watermark such as “strictly confidential” or “company secret” is selected or whether a specific mode such as woven pattern printing is selected rather than determining only a keyword in an original document, whereby the control section of the image forming apparatus 100 performs control concerning with which of the erasable toner and the unerasable toner printing is performed. This implementation is explained with reference to FIG. 14. The processor 204 of the PC 200 adds a symbol for designating the erasable toner to an object (an original document shown in FIG. 14) of electronic data (GDI) output by an application and adds a symbol for designating the unerasable toner to an object for printing a watermark, a woven pattern, or the like registered in advance in the PC 200 (the printer driver).

The printing order of the first printing section 16 and the second printing section 17 is not limited to this.

In the above explanation, the control section 13 determines presence or absence of a keyword for each page and performs control concerning with which of the unerasable toner and the erasable toner an image is printed. However, for example, it is conceivable that, if a keyword is present in a certain page, the first image not to be erased of the page is stored in the storing section 14 and, if a keyword is absent in the following pages, i.e., if the following pages are pages in which the first image is a totally white image, the stored first image is treated as the first image of the following pages and printed with the unerasable toner. By adopting such an implementation, the keyword is printed with the unerasable toner on the page following the page in which the keyword is present.

It is also conceivable that the first images and the second images of all the pages are stored in the storing section 14 and, if it is determined that a keyword is present in at least one page, the first image of the page in which the keyword is present is printed with the unerasable toner on a page in which a keyword is absent and the first image is a totally white image. By adopting such an implementation, concerning a job including a keyword, the keyword is printed with the unerasable toner on all pages.

By adopting the configuration of this embodiment, as in the first embodiment, it is possible to reduce leakage of information due to carelessness of the user. Further, since areas of a sheet other than a keyword indicating a confidentiality level (e.g., “company secret” or “department secret”) are erased, if a document having the same confidentiality level is printed, the sheet can be recycled and reused.

Further, if a PDL is used, it is possible to control printing according to a designated symbol without determining whether the image forming apparatus 100 performs printing in which of the printing sections. Therefore, it is possible to reduce a risk of erroneous identification.

The toners in the first and second embodiments include not only toners for obtaining hard copies in a multifunction peripheral, a facsimile, a copying machine, and a printer but also recording and display materials such as printing ink, a printing ribbon, and inkjet ink.

As explained above in detail, according to the technique described in this specification, a keyword of confidentiality information is printed with the unerasable toner. Therefore, it is possible to reduce a mistake of the user leaking confidential information without noticing that the confidential information is printed.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

1. An image forming apparatus comprising:
an input section configured to input information to be printed;
a first printing section configured to perform printing with a toner unerasable by an erasing device;
a second printing section configured to perform printing with a toner erasable by the erasing device; and
a control section configured to control the image forming apparatus to print, using the first printing section, at least a keyword stored in a storing section in advance among the information to be printed input by the input section and control the image forming apparatus to print, using the second printing section, information not printed by the first printing section.

2. The apparatus according to claim 1, wherein
the input section inputs image information as the information to be printed, and
the control section determines whether the keyword stored in the storing section in advance is present in the image information, if the keyword is present, controls the image forming apparatus to print the image information using the first printing section, and, if the keyword is absent, controls the image forming apparatus to print the image information using the second printing section.

3. The apparatus according to claim 1, wherein
the input section inputs information described in a page description language as the information to be printed, and
the control section determines whether the keyword stored in the storing section in advance is present in the page description language, if the control section determines that the keyword is present, controls the image forming apparatus to print, using the first printing section, an image generated from the page description language, and, if the control section determines that the keyword is absent, controls the image forming apparatus to print, using the second printing section, the image generated from the page description language.

4. The apparatus according to claim 1, wherein
the input section inputs image information as the information to be printed, and
the control section determines whether the keyword stored in the storing section in advance is present in the input image information and, if the keyword is present, creates a first image including an image of the keyword, creates a second image, which is an image obtained by excluding the image of the keyword from the input image information, controls the image forming apparatus to print the first image using the first printing section, and controls the image forming apparatus to print the second image using the second printing section.

5. The apparatus according to claim 4, wherein, if the keyword is present, the control section arranges, on the first image, a keyword image in a position and a size same as a position and a size of the keyword image present on the input image information.

6. The apparatus according to claim 1, wherein
the input section inputs information described in a page description language as the information to be printed, and
the control section determines whether a command in the page description language includes the keyword stored in the storing section in advance, if the command includes the keyword, renders an object generated according to the command in a first image, if the command includes no keyword, renders the object generated according to the command in a second image, controls the image forming apparatus to print the first image using the first printing section, and controls the image forming apparatus to print the second image using the second printing section.

7. The apparatus according to claim 1, wherein
the input section inputs information described in a page description language as the information to be printed, and
the control section acquires, from a command in the page description language, a symbol indicating in which of the first printing section and the second printing section printing is performed and controls the printing section corresponding to the symbol of the first and second printing sections to print an object generated according to the command.

8. The apparatus according to claim 1, wherein the control section determines whether the keyword stored in the storing section in advance is present in the input information to be printed and, if the keyword is present, controls the image forming apparatus to print, using the first printing section, pages following a page in which the keyword is present.

9. The apparatus according to claim 1, wherein the control section determines whether the keyword stored in the storing section in advance is present in the input information to be printed and, if the keyword is present, controls the image forming apparatus to print, using the first printing section, all pages of the input information to be printed.

10. An information processing apparatus comprising:
a storing section in which one or plural keywords are stored; and
a control section configured to acquire a keyword from the storing section, determine, for each object in electronic image data to be printed, whether the object is an object including the keyword and, if the object is the object including the keyword, add a symbol indicating printing with an erasable toner to a rendering command of the object and create a page description language of the electronic image data to be printed.

11. The apparatus according to claim 10, wherein, if the control section determines that the object is not the object including the keyword, the control section adds a symbol indicating printing with an erasable toner different from the symbol to the rendering command of the object and creates a page description language of the electronic image data to be printed.

12. An image forming system comprising:
an information processing apparatus configured to create information to be printed and transmit the information to be printed; and
an image forming apparatus configured to receive the information to be printed, print, using a first printing section configured to perform printing with an unerasable toner, at least a keyword stored in a storing section among the information to be printed, and print, using a second printing section configured to perform printing with an erasable toner, information not printed by the first printing section.

13. The system according to claim 12, wherein
the information processing apparatus creates image information as the information to be printed and transmits the image information, and
the image forming apparatus receives the image information, determines whether the keyword stored in the storing section in advance is present in the image information, if the keyword is present, prints the image information using the first printing section, and, if the keyword is absent, prints the image information using the second printing section.

14. The system according to claim 12, wherein
the information processing apparatus creates a page description language as the information to be printed and transmits the page description language, and
the image forming apparatus receives the page description language, determines whether the keyword stored in the storing section in advance is present in the page description language, if the keyword is present, prints an image generated from the page description language using the first printing section, and, if the keyword is absent, prints the image generated from the page description language using the second printing section.

15. The system according to claim 12, wherein
the information processing apparatus creates image information as the information to be printed and transmits the image information, and
the image forming apparatus receives the image information, determines whether the keyword stored in the storing section in advance is present in the image information, if the keyword is present, creates a first image including an image of the keyword, creates a second image, which is an image excluding the image of the keyword from the image information, prints the first image using the first printing section, and prints the second image using the second printing section.

16. The system according to claim 12, wherein
the information processing apparatus creates a page description language as the information to be printed and transmits the page description language, and
the image forming apparatus receives the page description language, determines whether a command in the page description language includes the keyword stored in the storing section in advance, if the command includes the keyword, renders an object generated according to the command in a first image, if the command includes no keyword, renders the object generated according to the command in a second image, prints the first image using the first printing section, and prints the second image using the second printing section.

17. The system according to claim 12, wherein
the information processing apparatus acquires the keyword from the storing section, determines, for each object in electronic image data to be printed, whether the object is an object including the keyword and, if the object is the object including the keyword, adds a symbol indicating printing with an unerasable toner to a rendering command of the object, creates a page description language of the electronic image data to be printed, and transmits the page description language, and
the image forming apparatus receives the page description language and prints, using the first printing section, an object generated according to the command including the symbol.

18. The system according to claim 17, wherein
if the information processing apparatus determines that the object is not the object including the keyword, the information processing apparatus adds a symbol indicating printing with an erasable toner different from the symbol to the rendering command of the object, creates a page description language of the electronic image data to be printed, and transmits the page description language, and
the image forming apparatus receives the page description language and prints, using the second printing section, an object generated according to the command including the symbol indicating the printing with the erasable toner.

19. An image forming method comprising:
inputting information to be printed;
printing, among the input information to be printed, at least a keyword stored in a storing section in advance using a first printing section configured to perform printing with a toner unerasable by an erasing device; and
printing information not printed by the first printing section using a second printing section configured to perform printing with a toner erasable by the erasing device.

20. The method according to claim 19, wherein
image information is input as the information to be printed,
it is determined whether the keyword stored in the storing section in advance is present in the image information,
if the keyword is present, the image information is printed by the first printing section, and
if the keyword is absent, the image information is printed by the second printing section.
